(19) United States
(12) Patent Application Publication
(10) Pub. No.: US 2026/0105414 A1
(43) Pub. Date: Apr. 16, 2026

(54) ARTIFICIAL INTELLIGENCE (AI) MODEL FOR MITIGATING INEFFICIENCIES IN THE DEVELOPMENT AND PRODUCTION OF VEHICLES

(71) Applicant: International Business Machines Corporation, Armonk, NY (US)

(72) Inventors: Ya Qian Fang, Jinhua (CN); Xiang Yu Yang, Xi'an (CN); Deng Xin Luo, Xi'an (CN); Yong Wang, Xi'an (CN); Yi Chen Zhong, Shanghai (CN); Jia Yong Xie, Xi'an (CN)

(21) Appl. No.: 18/915,159

(22) Filed: Oct. 14, 2024

(51) Int. Cl. G06Q 10/101; G06N 20/00

(52) U.S. Cl. CPC G06Q 10/101; G06N 20/00

(57) ABSTRACT

A method, according to one approach, includes, generating and maintaining an architecture of data associated with a development and production of a product, and causing a trained artificial intelligence (AI) model to identify, within the architecture of data, processes and sub-processes of the processes. The method further includes causing the trained AI model to identify inefficiencies within the processes and sub-processes, where the inefficiencies are based on predetermined research and development priorities including: time, quality and cost. Solutions for mitigating the identified inefficiencies are determined and the solutions are caused to be incorporated into the development and production of the product. A computer program product, according to another approach, includes one or more computer-readable storage media, and program instructions stored on the one or more storage media to perform any combination of features of the foregoing methodology.

### BACKGROUND

The present invention relates to artificial intelligence (AI), and more specifically, this invention relates to use of AI to refine a process.

The development and production of a large scale consumer product typically involves collaboration from multiple entities. For example, within the automobile industry, the development and production of vehicles involves collaboration between multiple teams. These teams include, but may not be limited to, concept development teams, marketing teams, investment teams, production teams, etc. These teams are often located at different geographical locations and therefore user devices are often relied upon for communicating between these teams. Use of these user devices creates congestion within network(s) that the user devices operate within.

### SUMMARY

A method, according to one approach, includes, generating and maintaining an architecture of data associated with a development and production of a product, and causing a trained artificial intelligence (AI) model to identify, within the architecture of data, processes and sub-processes of the processes. The method further includes causing the trained AI model to identify inefficiencies within the processes and sub-processes, where the inefficiencies are based on predetermined research and development priorities including: time, quality and cost. Solutions for mitigating the identified inefficiencies are determined and the solutions are caused to be incorporated into the development and production of the product.

A computer program product, according to another approach, includes one or more computer-readable storage media, and program instructions stored on the one or more storage media to perform any combination of features of the foregoing methodology.

A computer system, according to another approach, includes a processor set, one or more computer-readable storage media, and program instructions stored on the one or more storage media to cause the processor set to perform any combination of features of the foregoing methodology.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach of the present invention.

FIG. 2 is a flowchart of a method, in accordance with one approach of the present invention.

FIG. 3 is a structure, in accordance with one approach of the present invention.

FIG. 4 is a flowchart of architectures, in accordance with one approach of the present invention.

FIG. 5 is a flowchart of optimizations of processes and sub-processes of the processes, in accordance with one approach of the present invention.

FIG. 6 is a flowchart of a method, in accordance with one approach of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for using an AI model for mitigating inefficiencies in the development and production of vehicles.

In one general approach, a method includes, generating and maintaining an architecture of data associated with a development and production of a product, and causing a trained artificial intelligence (AI) model to identify, within the architecture of data, processes and sub-processes of the processes. The method further includes causing the trained AI model to identify inefficiencies within the processes and sub-processes, where the inefficiencies are based on predetermined research and development priorities including: time, quality and cost. Solutions for mitigating the identified inefficiencies are determined and the solutions are caused to be incorporated into the development and production of the product.

A technical effect of causing the trained AI model to identify inefficiencies within the processes and sub-processes includes a development of target areas to address during the development and production of the product in order to reduce network congestion associated with the development and production of the product, reduce tasks performed during the development and production of the product, preserve processing potential during the development and production of the product, among other benefits.

The product may be a vehicle, and the processes may, in some approaches, include determining a start-up plan for the vehicle, defining production of the vehicle, preparing for initiation of the determined start-up plan, initiating the determined start-up plan, seeking investment approval for the vehicle, anticipating delays, determining conditions of the vehicle, research and development of the vehicle, identifying a pilot for the vehicle, producing a relatively small sample lot of the vehicle, performing quality control based on the relatively small sample lot of the vehicle, and associating an end of the product.

A technical effect of identifying processes and sub-processes of the processes for approaches in which the product is a vehicle includes a relevant (target) portion of the data of the data architecture being established for identifying inefficiencies in the development and production of the vehicle. This way, the entire architecture of data is not processed, but instead, a relevant sub-portion thereof is defined for reducing an extent of data that is further processed by the trained AI model.

The method may further include training the AI model to identify training processes and training sub-processes within a predetermined training set of data. Training the AI model may include causing the AI model to analyze the predetermined training set of data, causing the AI model to make a guess as to the training processes and the training sub-processes within the predetermined training set of data, and in response to a determination that the guess is correct, providing reward based feedback to the AI model to increase an accuracy of the model.

A technical effect of training the AI model, and more specifically, using reward based feedback for training the AI model includes processing resources being preserved, as the AI model is refined to at least a predetermined threshold of accuracy before being used. Furthermore, an extent of computer operations associated with use of the AI model are ultimately relatively reduced as a technical effect of the training of the AI model. This is because the model is trained to compute relatively accurately rather than otherwise performing inaccurate guesses.

The AI model may be determined to be trained in response to a determination that the accuracy of the AI model exceeds a predetermined threshold of accuracy.

A technical effect of training the AI model until the predetermined threshold of accuracy is exceeded (or in some cases met) includes the prevention of AI model resources being deployed prematurely. Premature deployment of the AI model would otherwise cause inaccurate processing operations to be performed (based on the accuracy of the model not yet meeting or exceeding the predetermined threshold), which would lead to unnecessary contributions to network congestion (unnecessary with respect to otherwise waiting for the AI model to be fully trained before deployment).

Causing the trained AI model to identify inefficiencies within the processes and sub-processes may include causing the trained AI model to identify a first of the processes having a starting point and a destination point, where the first process includes a plurality of sub-processes that, along a serial logical path, include associated points between the starting point and the destination point. The determining solutions for mitigating the identified inefficiencies may include causing the trained AI model to split points of the sub-processes along the serial logical path into a plurality of parallel logical paths each having the points of an associated one of the sub-processes. Causing the solutions to be incorporated into the development and production of the product may include causing the sub-process of a first of the parallel logical paths to be performed during the development and production of the product, and causing the sub-processes of a remainder of the parallel logical paths to not be performed during the development and production of the product.

A technical effect of causing the sub-process of the first parallel logical paths to be performed during the development and production of the product, while causing the sub-processes of the remainder of the parallel logical paths to not be performed during the development and production of the product includes a reduction in the number of points that are performed during the development and production of the product. More specifically, processing resources that are expended in development and production of the product are preserved because computer operations of a device used to generate and develop the product are reduced by performing points of one of the parallel paths rather than all of the points of the first process in serial. For this reason, it is evident how the identified inefficiencies are based on predetermined research and development priorities including time, quality and cost. This is because otherwise performing all of the points of the first process in serial would consume more time. Furthermore, a cost associated with a delayed release of the product based on otherwise performing all of the points of the first process in serial are also relatively greater than a cost of producing and delivering the product in relatively less time. Finally, a technical effect of the determined solution includes a quality of the product being increased preserved processing potential may optionally be expended on quality control computer processing operations.

The performance of the first parallel logical path may result in the development and production of the product in relatively less time than a resulting time of a performance of any of the logical paths of the remainder of the parallel logical paths for the development and production of the product.

A technical effect of selecting a relatively most time efficient one of the logical paths for development and production of the product includes mitigation of the identified efficiencies with respect to the time-based predetermined research and development priority.

The performance of the first parallel logical path may result in the development and production of the product for relatively less cost than a cost associated with a performance of any of the logical paths of the remainder of the parallel logical paths for the development and production of the product.

A technical effect of selecting a relatively most cost efficient one of the logical paths for development and production of the product includes mitigation of the identified efficiencies with respect to the cost-based predetermined research and development priority.

The performance of the first parallel logical path may result in the development and production of the product with relatively more product quality than a product quality associated with a performance of any of the logical paths of the remainder of the parallel logical paths for the development and production of the product.

A technical effect of selecting a path based on the path being estimated to result in a relatively best quality product (with respect to the other logical paths) for development and production of the product includes mitigation of the identified efficiencies with respect to the quality-based predetermined research and development priority. Furthermore, another technical effect includes post-production computer operations being reduced, as quality control processing operations process relatively less instances of product quality issues as a result of the techniques described herein.

Causing the trained AI model to identify inefficiencies within the processes and sub-processes may include causing the trained AI model to identify a first of the processes having a starting point and a destination point, where the first process includes a sub-process having associated points between the starting point and the destination point. Determining solutions for mitigating the identified inefficiencies may include causing the trained AI model to identify a first of the points of the sub-process that does not satisfy thresholds associated with the predetermined research and development priorities. The causing the solutions to be incorporated into the development and production of the product may include causing the first point to be removed from the sub-process during performance of the development and production of the product.

A technical effect of removing point(s), that are determined to not satisfy thresholds associated with the predetermined research and development priorities, from performance of the development and production of the product includes mitigating inefficiencies from the development and production of the product. More specifically, by mitigating inefficiencies from the development and production of the product, the product is developed and produced using relatively less processing resources (as points are directly removed from processes), in relatively less time, at a relatively better quality, and/or for relatively less cost.

In another general approach, a computer program product includes one or more computer-readable storage media, and program instructions stored on the one or more storage media to perform any combination of features of the foregoing methodology. Similar technical effects are obtained.

In another general approach, a computer system includes a processor set, one or more computer-readable storage media, and program instructions stored on the one or more storage media to cause the processor set to perform any combination of features of the foregoing methodology. Similar technical effects are obtained.

In one general approach, a method includes, generating and maintaining an architecture of data associated with a development and production of a product that is a vehicle, training an AI model to identify training processes and training sub-processes within a predetermined training set of data, and causing the trained AI model to identify, within the architecture of data, processes and sub-processes of the processes. The method further includes causing the trained AI model to identify inefficiencies within the processes and sub-processes, where the inefficiencies are based on predetermined research and development priorities including: time, quality and cost. Solutions for mitigating the identified inefficiencies are determined and the solutions are caused to be incorporated into the development and production of the vehicle.

A technical effect of training and deploying an AI model to identify inefficiencies within the processes and sub-processes includes a development of target areas to address during the development and production of the vehicle in order to reduce network congestion associated with the development and production of the vehicle, reduce tasks performed during the development and production of the vehicle, preserve processing potential during the development and production of the vehicle, among other benefits.

A technical use case of the foregoing methodology includes an injection of AI potential into the birth process of vehicle products to identify and mitigate inefficiencies that would otherwise exist in future the development and production of vehicles. This injection may be performed by performing any combination of features of the foregoing methodology above, e.g., such as by deploying the trained AI models as a service to corporations that experience inefficiencies in the development and production of their vehicles. This injection comprehensively improves the end-to-end collaboration ability of vehicle product birth and improves the work efficiency of computations performed within organizations during development and production of a vehicle. Furthermore, this injection comprehensively optimizes processes of the development and production of the vehicle by shortening the vehicle research and development cycle, and bringing relatively more capital and time support for the introduction of new technologies and the upgrade of new platforms.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as AI model training and use code of block 150 for using an AI model for mitigating inefficiencies in the development and production of vehicles. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

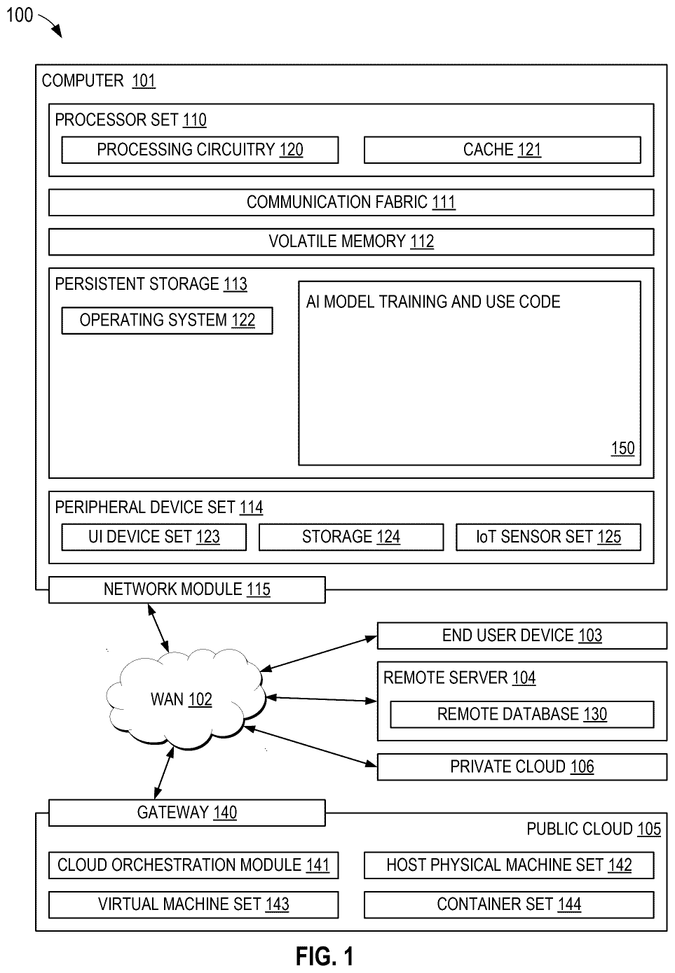

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As mentioned elsewhere above, the development and production of a large scale consumer product typically involves collaboration from multiple entities. For example, within the automobile industry, the development and production of vehicles involves collaboration between multiple teams. These teams include, but may not be limited to, concept development teams, marketing teams, investment teams, production teams, etc. These teams are often located at different geographical locations and therefore user devices are often relied upon for communicating between these teams. Use of these user devices creates congestion within network(s) that the user devices operate within.

In addition to collaboration between user devices (in the process of developing a new vehicle) creating congestion within network(s), it should be noted that, competition in the automobile industry is fierce, especially with the rapid rise of new energy car companies, e.g., electric vehicle companies, hybrid vehicle companies, etc. This creates pressure to deliver vehicles (in an ever changing market landscape) within relatively short deadlines. This pressure promotes rushed decisions and thereby network traffic that is riddled with errors and inefficiencies. For example, in each car manufacturer, the business process formulation and release parties are often inconsistent with personnel who carry out actual business activities, resulting in the business process related network traffic that cannot be used to guide the actual business work. This conflict alone represents a notable portion of network traffic that is both unnecessarily transmitted and unnecessarily processed by computer devices. This is also an issue for vehicle manufacturing enterprises in the context of cross-field, cross-department, cross-professional, and complex business work. This kind of dissociation phenomenon seriously affects business collaboration within the process of vehicle research and development. This results in prolonged research and development cycles, slow acceptance of new technology introduction, and serious uncertainty. In other words, a few issues that the dissociation phenomenon mentioned above leads to include congested network traffic, processing resources being unnecessarily expended on tasks that do not contribute to the delivery of a product, and wasted physical resources. Accordingly, there is a need for reducing network traffic and inefficiencies associated with the production of a product (more specifically a vehicle) by identifying and correcting inefficiencies within the development and production chain of the product.

In sharp contrast to the deficiencies described above, the techniques of approaches described herein optimize the production chain of a vehicle by identifying and correcting inefficiencies within the development and production process of the vehicle.

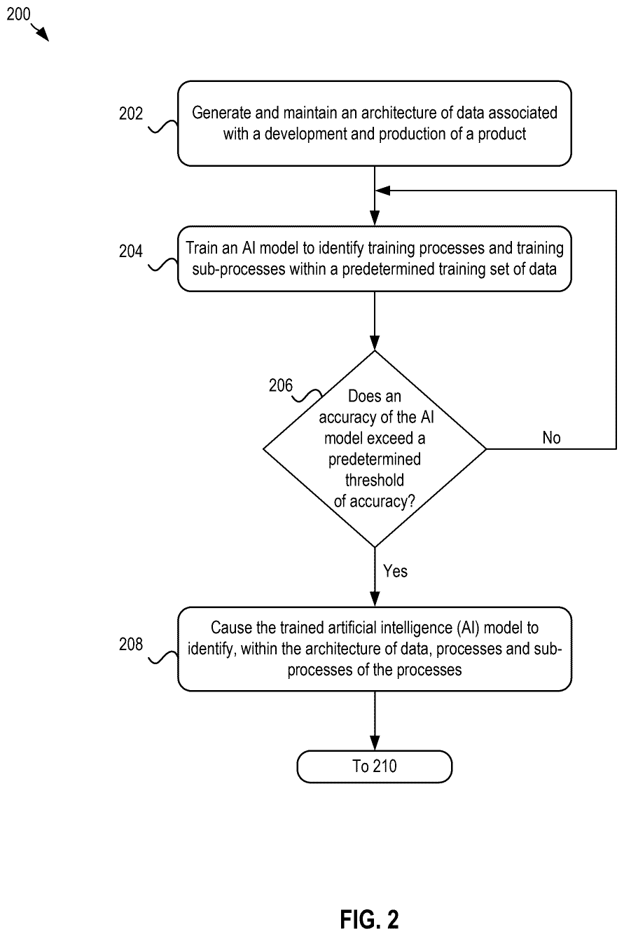

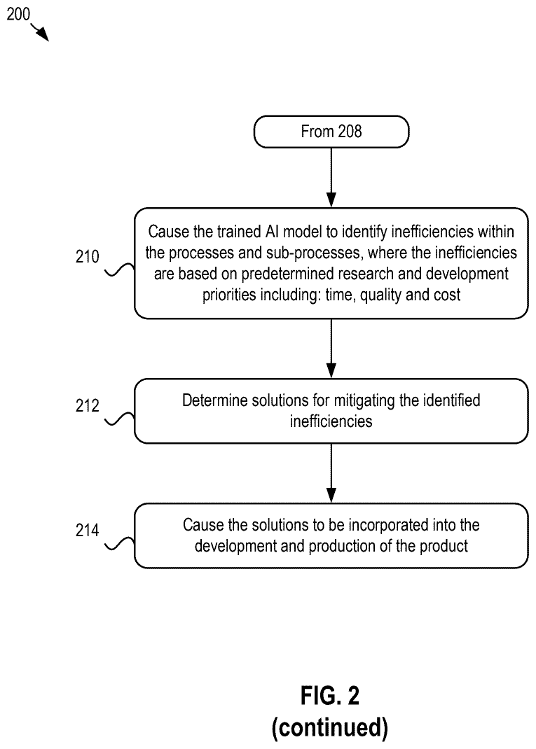

Now referring to FIG. 2, a flowchart of a method 200 is shown according to one approach. The method 200 may be performed in accordance with aspects of the present invention in any of the environments depicted in FIGS. 1-6, among others, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that operations of method 200 are described to be performed with respect to development and production of a product. In some preferred approaches, the product is a vehicle. However, in some other approaches, the operations described herein may be modified to be additionally and/or alternatively performed with respect to another type of product, e.g., a computer program, a user device, food, etc.

Operation 202 includes generating and maintaining an architecture of data associated with a development and production of the product. In some approaches, the activities of the architecture of data may be a data lake that is fed information by user devices that are determined to be associated with developments and production of previous product(s) determined to have at least a predetermined degree of similarity with the product. The data lake may be structured into a known type of architecture format using techniques that would become apparent to one of ordinary skill in the art after reading the descriptions herein. These techniques may be used to at least initially create the architecture of data. In contrast, maintaining the architecture of data may, in some approaches, include replacing relatively oldest data with relatively newest data, e.g., as new data is fed into the data lake an equal size portion of relatively oldest data is deleted from the data lake. This way, the data of the architecture of data is ongoingly transformed over time in order to ensure that the data of architecture of data is not outdated (does not include more than a predetermined amount of stale data). This updating also ultimately reduces an extent of processing resources that are expended in approaches in which the architecture of data of analyzed. These previous product(s) may, in some approaches, include previous versions of the product, while the product may be scheduled to be developed, produced and released at a future predetermined date. More specifically, the previous product(s) may be a previous year's version of a vehicle, while the product may be vehicle that is scheduled to be developed, produced and released for a current year. Accordingly, in some approaches, data of the architecture of data may be based on computer operations that contributed to the development and production of the previous product(s) determined to have at least the predetermined degree of similarity with the product. These computer operations may be of a type that would become apparent to one with ordinary skill in the art after reading the descriptions herein. In some approaches, data fed into the architecture of data may include electronic communications sent for securing resources for developing the previous product(s) determined to have at least the predetermined degree of similarity with the product, e.g., to secure funding, to secure raw resources for producing the previous product(s) determined to have at least the predetermined degree of similarity with the product, to contract a manufacturing team for developing the previous product(s) determined to have at least the predetermined degree of similarity with the product, etc. In some other approaches, the activities may be based on manufacturing at least some portion of the previous product(s), e.g., performing welding tasks, instructions electronically issued for controlling assembly robot components, etc. In some other approaches, the data of the architecture may include photos and/or video feeds that document the developments and production of previous product(s) determined to have at least the predetermined degree of similarity with the product.

Operation 204 includes training an AI model to identify training processes and training sub-processes within a predetermined training set of data. The training processes and training sub-processes may be similar to the types of processes and sub-processes described elsewhere herein, e.g., see operation 208. For context, once trained, the AI model may be used to analyze and evaluate the architecture of data. Accordingly, the predetermined training set of data may include data that is based on the development and production of a predetermined training product. In some approaches, the predetermined training product is a vehicle (e.g., a same type of product that the architecture of data is based on), while in some other approaches, the predetermined training product may be any other type of product. For further context, for descriptive purposes herein, a “process” may be defined as a series of actions and/or steps (also referred to as “point(s)” of a process herein) that are performed in order to achieve a task and/or goal. For example, in one illustrative approach, a research and development process may include a series of points, e.g., securing funding for research, dividing up an obtained research grant, developing a small scale model, testing the small scale model, etc., that may be performed in order to achieve a goal of researching and developing a new car model. Furthermore, for context, in some approaches, a “sub-process” of a process may refer to some, but not all of the points of the process. For example, as will be described in greater detail elsewhere below, in some approaches, a process may include a plurality of sub-processes between a starting point and a destination point of the process. The points of any of these sub-processes may be performed with the starting point and the destination point in order to perform the process.

In some approaches, the AI model is trained to identify different processes and sub-processes that, when performed, each result in the same outcome, e.g., beginning at a starting point (a first action and/or step of the process) and reaching a destination point (a last action and/or step of the process). Furthermore, in some approaches, the AI model is trained to identify data of an architecture of data that is not associated with one or more steps of a process or sub-process thereof. For example, in some approaches, the predetermined training set of data may include logs of code executed in the process of developing and producing a previous model of a vehicle, and the AI model may be trained to identify portions of code that did not execute correctly and/or were executed but resulted to an error and/or delay in the process of developing and producing the previous model of the vehicle. In some other approaches, portions of unrelated data may intentionally be added to the predetermined training set of data for the AI model to potentially identify and exclude from processing. Training the AI model to identify unrelated portions of data trains the AI model to refine a set of data, e.g., such as the architecture of data, before further analyzing the data set reduces a processing load that the AI model performs over time. In other words, processing resources associated with the performance of method 200 are preserved and an extent of computer operations associated with the performance of method 200 are ultimately relatively reduced as a technical effect of the training of the AI model.

Training the AI model may, in some approaches, include causing the AI model to analyze the predetermined training set of data. The AI model may be caused, e.g., instructed, to analyze the predetermined training set of data using analyzation techniques that would become apparent to one of ordinary skill in the art after reading the descriptions herein. In some approaches, these techniques include natural language processing (NLP) techniques. The techniques may additionally and/or alternatively include data comparison and correlation techniques. The techniques may additionally and/or alternatively include data analysis and forecasting techniques.

During the training, the AI model may be caused, e.g., instructed, to make a guess as to the training processes and the training sub-processes within the predetermined training set of data. These guesses may be verified, and reward based feedback may optionally be implemented in order to tune an accuracy of the AI model. For example, in some approaches, in response to a determination that the guess is correct, reward based feedback is provided to the AI model to increase an accuracy of the model. In some of such approaches, the reward feedback may be implemented using a subject matter expert (SME) that generally understands whether the guess is accurate for an initial predetermined number of examples of the training set of data. However, to prevent costs associated with relying on manual actions of a SME, in another approach, reward feedback may be implemented using techniques for training a BERT model, as would become apparent to one skilled in the art after reading the present disclosure. In some preferred approaches, the AI model is determined to be trained in response to a determination that the accuracy of the AI model exceeds a predetermined threshold of accuracy, e.g., see “Yes” logical path of decision 206. In response to such a determination, in some approaches, method 200 optionally continues to operation 208. In contrast, in response to a determination that the accuracy of the AI model does not exceed the predetermined threshold of accuracy, e.g., as illustrated by the “No” logical path of decision 206, training of the AI model preferably continues. A technical effect of training the AI model until the predetermined threshold of accuracy is exceeded (or in some cases met) includes the prevention of AI model resources being deployed prematurely. Premature deployment of the AI model would otherwise cause inaccurate processing operations to be performed (based on the accuracy of the model not yet meeting or exceeding the predetermined threshold), which would lead to unnecessary contributions to network congestion (unnecessary with respect to otherwise waiting for the AI model to be fully trained before deployment).

In some further approaches, the AI model may be a neuromyotonic AI model that may improve performance of computer devices in an infrastructure associated with analysis of an architecture of data, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI model to collect and analyze information and/or feedback potentially received from the training. Such an AI model ensures that approaches in which the training architecture of data is a data lake and/or the architecture of data analyzed once the AI model is trained is a data lake, where the scale of such analysis and determinations would not otherwise be feasible for a human to perform. This is because humans are not able to efficiently evaluate such extensive collections of data within a timely manner, and would otherwise incorporate processing delays and errors in the evaluation in the process of attempting to do so. Accordingly, management of operations described herein is not able to be achieved by human manual actions.

Operation 208 includes causing the trained AI model to identify, within the architecture of data, processes and sub-processes of the processes. For context, a technical effect of identifying processes and sub-processes of the processes for approaches in which the product is a vehicle includes a relevant (target) portion of the data of the data architecture being established for identifying inefficiencies in the development and production of the vehicle. This way, the entire architecture of data is not processed, but instead, a relevant sub-portion thereof is defined for reducing an extent of data that is further processed by the trained AI model.

The processes, may, in some approaches, be based on a vehicle product “birth process” which may be divided into a plurality of milestone stages that each correspond to different work packages at different stages of development and production of the vehicle. In some approaches, a longitudinal view of these stages is the view of work disassembly until the disassembly reaches the atomic level. Then, based on the sequence relationship of atomic-level activities of service maintenance, a business activity network diagram of a real service execution level of the processes may be determined. An illustrative example of one of the processes includes determining a start-up plan for the vehicle, which may include a plurality of points of operations performed to determine such a plan, e.g., AI model brainstorming, electronic novelty web searches, etc. In another approach, the processes may additionally and/or alternatively include a process for defining production of the vehicle. Defining production of the vehicle may include points for a plan of the assembly and infrastructure associated with production of the vehicle. In another approach, the processes may additionally and/or alternatively include a process for preparing for initiation of the determined start-up plan, and/or a process for initiating the determined start-up plan. In another approach, the processes may additionally and/or alternatively be a process for seeking investment approval for the vehicle. This process may include points associated with fundraising, allocating a budget, forecasting material costs, etc. In another approach, the processes may additionally and/or alternatively be a process for anticipating delays, e.g., forecasting weather delays, supply chain delays, etc., that may be experienced along an expected period of time that the development and production of the vehicle will occur. The processes may additionally and/or alternatively be a process for determining conditions of the vehicle. These conditions may include specifications of the vehicle that are based on conditions that the vehicle is expected to experience during future consumer use. According to several approaches, the processes may additionally and/or alternatively be a process for researching and development of the vehicle, a process for identifying a pilot for the vehicle (determining characteristics of an average consumer of the vehicle), a process for producing a relatively small sample lot of the vehicle, a process for performing quality control based on the relatively small sample lot of the vehicle, and a process for associating an end of the product (determining a lifecycle of the vehicle, determining when a subsequent version of the vehicle would thereafter become available, etc.).

Operation 210 includes causing the trained AI model to identify inefficiencies within the processes and sub-processes. The inefficiencies are, in some preferred approaches, based on predetermined research and development priorities including time, quality and cost. In some other approaches, the predetermined research and development priorities may be any combination of the predetermined research and development priorities mentioned above and/or one or more other predetermined priorities.

For context, a technical effect of causing the trained AI model to identify inefficiencies within the processes and sub-processes includes a development of target areas to address during the development and production of the product in order to reduce network congestion associated with the development and production of the product, reduce tasks performed during the development and production of the product, preserve processing potential during the development and production of the product, among other benefits. Various illustrative approaches for causing the trained AI model to identify inefficiencies within the processes and sub-processes are described below.

In a first approach, causing the trained AI model to identify inefficiencies within the processes and sub-processes is based on a predetermined and/or optimization technique. More specifically, causing the trained AI model to identify inefficiencies within the processes and sub-processes using the predetermined and/or optimization technique may include causing the trained AI model to identify a first of the processes having a starting point and a destination point. It may be recalled that the starting point is a first action and/or step of the process, while the destination point is a last action and/or step of the process. Between the starting point and the destination point, a determination may be made as to whether the first process includes any actions that are scheduled to be performed in serial, e.g., sequentially one after another. In some approaches, the first process includes a plurality of sub-processes that, along a serial logical path, include associated points between the starting point and the destination point. A plurality of points of a sub-process of the first process performed in serial may be identified as an inefficiency in response to a determination that at least some of the points of the first process can otherwise be executed in parallel independently of some of the other points of the first process. For context, in some descriptions of the predetermined and/or optimization technique, first points of the first process determined to capable of being otherwise performed in parallel independently of some of the other points of the first process may be referred to as “associated points between the starting point and the destination point” of the first process.

In order to mitigate identified inefficiencies, in some approaches, method 200 includes determining solutions for mitigating the identified inefficiencies, e.g., see operation 212. These determined solutions may then be caused to be incorporated into the development and production of the product, e.g., see operation 214. With continued reference to the predetermined and/or optimization technique described above, in some approaches, determining solutions for mitigating the identified inefficiencies includes causing the trained AI model to split points of the sub-processes along the serial logical path into a plurality of parallel logical paths, where the logical paths may each have points of an associated one of the sub-processes. This way, an execution path of the process is consolidated (by dividing the points into different independent execution paths), as the determined solution includes breaking the points that would otherwise have been performed in serial, into sub-processes that are able to be performed in parallel independently. The solutions may, in some approaches, be caused to be incorporated into the development and production of the product by causing the sub-process of a first of the parallel logical paths to be performed during the development and production of the product, and causing the sub-processes of a remainder of the parallel logical paths to not be performed during the development and production of the product. A technical effect of causing the sub-process of the first parallel logical paths to be performed during the development and production of the product, while causing the sub-processes of the remainder of the parallel logical paths to not be performed during the development and production of the product includes a reduction in the number of points that are performed during the development and production of the product. More specifically, processing resources that are expended in development and production of the product are preserved because computer operations of a device used to generate and develop the product are reduced by performing points of one of the parallel paths rather than all of the points of the first process in serial. For this reason, it is evident how the identified inefficiencies are based on predetermined research and development priorities including time, quality and cost. This is because otherwise performing all of the points of the first process in serial would consume more time. Furthermore, a cost associated with a delayed release of the product based on otherwise performing all of the points of the first process in serial are also relatively greater than a cost of producing and delivering the product in relatively less time. Finally, a technical effect of the determined solution includes a quality of the product being increased preserved processing potential may optionally be expended on quality control computer processing operations.

In a second approach, causing the trained AI model to identify inefficiencies within the processes and sub-processes may additionally and/or alternatively be based on a predetermined baseline period optimization technique. The predetermined baseline period optimization technique, in some preferred approaches, includes estimating execution times for each of the logical paths of steps of the plurality of logical paths, e.g., such as the plurality of logical paths of the first process mentioned elsewhere above. Execution times for such logical paths may be estimated using estimation techniques of a type that would become apparent to one of ordinary skill in the art after reading the descriptions herein. In some approaches, these estimation techniques include performing simulations of the points on a relatively small scale, e.g., such as by using an AI model trained to perform simulations of executions of logic. In some approaches, the different parallel logical paths may be ranked based on these estimations, e.g., from relatively least time consuming to relatively most time consuming. Based on these rankings, in some illustrative approaches, a determination may be made that the performance of the first parallel logical path results in the development and production of the product in relatively less time than a resulting time of a performance of any of the logical paths of the remainder of the parallel logical paths for the development and production of the product. A technical effect of selecting a relatively most time efficient one of the logical paths for development and production of the product includes mitigation of the identified efficiencies with respect to the time-based predetermined research and development priority.

In a third approach, causing the trained AI model to identify inefficiencies within the processes and sub-processes may additionally and/or alternatively be based on a predetermined cost optimization technique. The cost optimization technique, in some preferred approaches, includes estimating execution costs for each of the logical paths of steps of the plurality of logical paths, e.g., such as the plurality of logical paths of the first process mentioned elsewhere above. Execution costs for such logical paths may be estimated using estimation techniques of a type that would become apparent to one of ordinary skill in the art after reading the descriptions herein. In some approaches, these estimation techniques include performing cost analysis based on current and projected market trends, which preferably incorporates predetermined factors including, but not limited to, cost of raw materials needed for the product, cost of labor, cost of power needed to run computer devices and/or electronics for development and production of the product, etc. In some approaches, this analysis may be performed using an AI model trained to perform cost analysis based on the predetermined factors mentioned above. In some approaches, the different parallel logical paths may be ranked based on these estimated execution costs, e.g., from relatively least costly to relatively most costly. Based on these rankings, in some illustrative approaches, a determination may be made that the performance of the first parallel logical path results in the development and production of the product for relatively less cost than a cost associated with a performance of any of the logical paths of the remainder of the parallel logical paths for the development and production of the product. A technical effect of selecting a relatively most cost efficient one of the logical paths for development and production of the product includes mitigation of the identified efficiencies with respect to the cost-based predetermined research and development priority.

In a fourth approach, causing the trained AI model to identify inefficiencies within the processes and sub-processes may additionally and/or alternatively be based on a predetermined product quality optimization technique. The predetermined product quality optimization technique, in some preferred approaches, includes estimating resulting quality of the product for each of the logical paths of steps of the plurality of logical paths, e.g., such as the plurality of logical paths of the first process mentioned elsewhere above. Product quality for such logical paths may be estimated using estimation techniques of a type that would become apparent to one of ordinary skill in the art after reading the descriptions herein. In some approaches, these estimation techniques include performing product quality analysis by instructing an AI simulator to generate a batch of the product and estimate quality issues of the batch of the product. In some other approaches, these simulations may additionally and/or alternatively be based on the AI simulator considering previous versions of the product, and quality issues previously detected in the previous versions of the product, e.g., based on the AI simulator parsing historical log files of the architecture of data. In some approaches, the different parallel logical paths may be ranked based on these estimated resulting product quality, e.g., from a relatively best resulting quality (based on a relatively fewest estimated quality issues of the product) to a relatively worst resulting quality (based on relatively a most estimated quality issues of the product). Based on these rankings, in some illustrative approaches, a determination may be made that the performance of the first parallel logical path results in the development and production of the product with relatively more product quality than a product quality associated with a performance of any of the logical paths of the remainder of the parallel logical paths for the development and production of the product. In other words, the first parallel logical path may be caused to be performed instead of the other logical paths based on the rankings. A technical effect of selecting a path based on the path being estimated to result in a relatively best quality product (with respect to the other logical paths) for development and production of the product includes mitigation of the identified efficiencies with respect to the quality-based predetermined research and development priority. Furthermore, another technical effect includes post-production computer operations (of a device performing method 200) being reduced, as quality control processing operations process relatively less instances of product quality issues as a result of the techniques described herein.

In a fifth approach, causing the trained AI model to identify inefficiencies within the processes and sub-processes may additionally and/or alternatively be based on a predetermined sequence optimization technique. Within such an approach, causing the trained AI model to identify inefficiencies within the processes and sub-processes may include causing the trained AI model to identify one of the processes having a starting point and a destination point. To distinguish from the example elsewhere above, this identified process may be referred to in some descriptions below as the “second process.” The second process may include a sub-process having associated points between the starting point and the destination point.

Inefficiencies may be identified within the second process using techniques similar to those described elsewhere herein, e.g., see operation 210, and solutions may be determined for the identified inefficiencies. Determining solutions for mitigating the inefficiencies identified in the second process may, in some approaches, include causing the trained AI model to identify a first of the points of a sub-process of the second process, where the first point does not satisfy thresholds associated with the predetermined research and development priorities. These thresholds associated with the predetermined research and development priorities may be set and dynamically adjusted based on feedback received and input into the trained AI model, e.g., the thresholds may be increased by the trained AI model in response to a determination that negative feedback is received and/or the thresholds may be maintained and/or decreased by the trained AI model in response to a determination that positive feedback is received. In order to mitigate the identified inefficiencies, in some approaches, causing the solutions to be incorporated into the development and production of the product includes causing the first point to be removed from the sub-process during performance of the development and production of the product, e.g., the first point is not performed while the other points of the sub-process of the second process are performed during the performance of the development and production of the product.

A technical effect of removing point(s), that are determined to not satisfy thresholds associated with the predetermined research and development priorities, from performance of the development and production of the product includes mitigating inefficiencies from the development and production of the product. More specifically, by mitigating inefficiencies from the development and production of the product, the product is developed and produced using relatively fewer processing resources (as points are directly removed from processes), in relatively less time, at a relatively better quality, and/or for relatively less cost.

During and/or subsequent to development and production of the product, feedback may be received. In some approaches, the feedback is received from user devices that collect user ratings of the product. In some other approaches, the feedback is obtained during the development of the product, such as where consumer surveys are output to user devices by the trained AI model to gauge a prototype in approaches in which the product is a vehicle. The feedback may be fed into the trained AI model, and used to refine the accuracy of the trained AI model over time. For example, during development of the product, the thresholds associated with the predetermined research and development priorities may be adjusted based on user feedback.

In addition to the beneficial technical effects described herein, it should be noted that the techniques described herein solve the longstanding issue of dissociation phenomenon in the actual business and the birth process of vehicle products. Furthermore, these techniques comprehensively improve the end-to-end business collaboration ability of vehicle product birth and improve the work efficiency of computations performed within organizations during development and production of a vehicle. Finally, these techniques comprehensively optimize processes of the development and production of the vehicle by shortening the vehicle research and development cycle, and bringing relatively more capital and time support for the introduction of new technologies and the upgrade of new platforms.

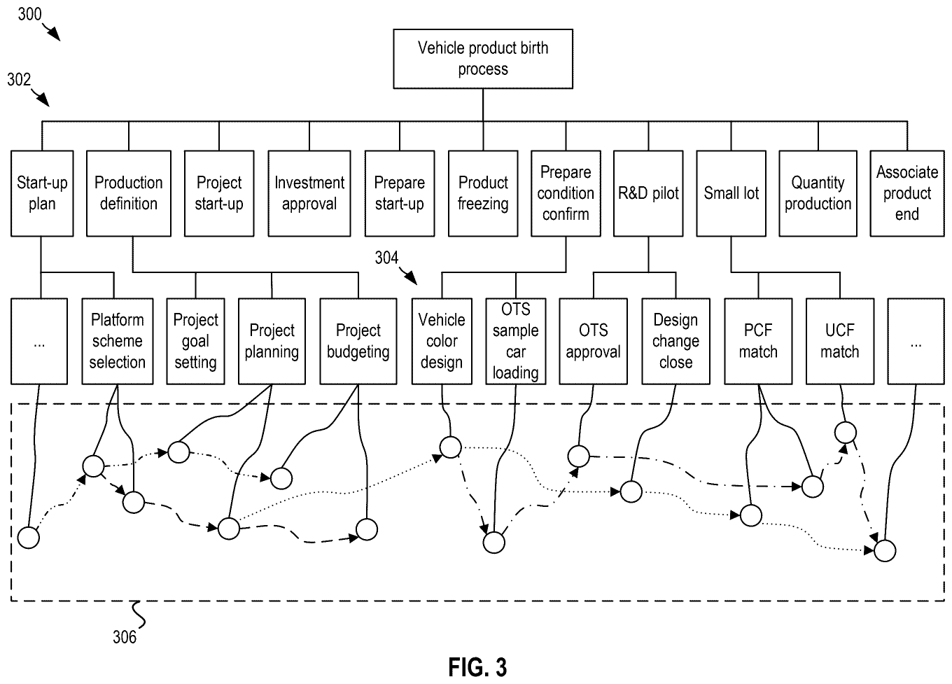

FIG. 3 depicts a structure 300, in accordance with one approach. As an option, the present structure 300 may be implemented in conjunction with features from any other approach listed herein, such as those described with reference to the other FIGS. Of course, however, such structure 300 and others presented herein may be used in various applications and/or in permutations which may or may not be specifically described in the illustrative approaches listed herein. Further, the structure 300 presented herein may be used in any desired environment.

The structure 300 illustrates a logical breakdown of processes and sub-processes of a vehicle product birth process (also referred to herein as development and production of a vehicle). More specifically, in some approaches, the structure 300 may be an architecture of data that is generated and maintained in order to determine and implement efficiencies into the development and production of a vehicle. It should be noted that these efficiencies are not otherwise available to be performed by car manufacturers based on the inability of the car manufacturing industry to sort out large amounts of data in various fields. More specifically, the techniques described herein mitigate inefficiencies of a vehicle development and production process by dismantling and evaluating the vehicle birth process at atomic-level activities. This breakdown includes the evaluation of the vehicle birth process based on the three dimensions including time “T” (plan/time), quality “Q” and cost “C” to design target optimizations and correct identified inefficiencies.

A first tier 302 of the structure 300 includes a plurality of processes, e.g., see start-up plan, production definition, project start-up, etc. Some of the processes include sub-processes of a second tier 304 of the structure 300, e.g., see . . . , platform scheme selection, project goal setting, etc.

A trained AI model may be caused to identify inefficiencies within the processes and sub-processes. As described elsewhere herein, in some approaches, the inefficiencies may be mitigated using determined solutions. In some of these approaches, the solution may be determined by analyzing steps of the sub-processes, e.g., see logical paths of the sub-processes in a third tier 306 of the structure 300. The solutions may be caused to be incorporated into the development and production of the vehicle using techniques described in method 200.

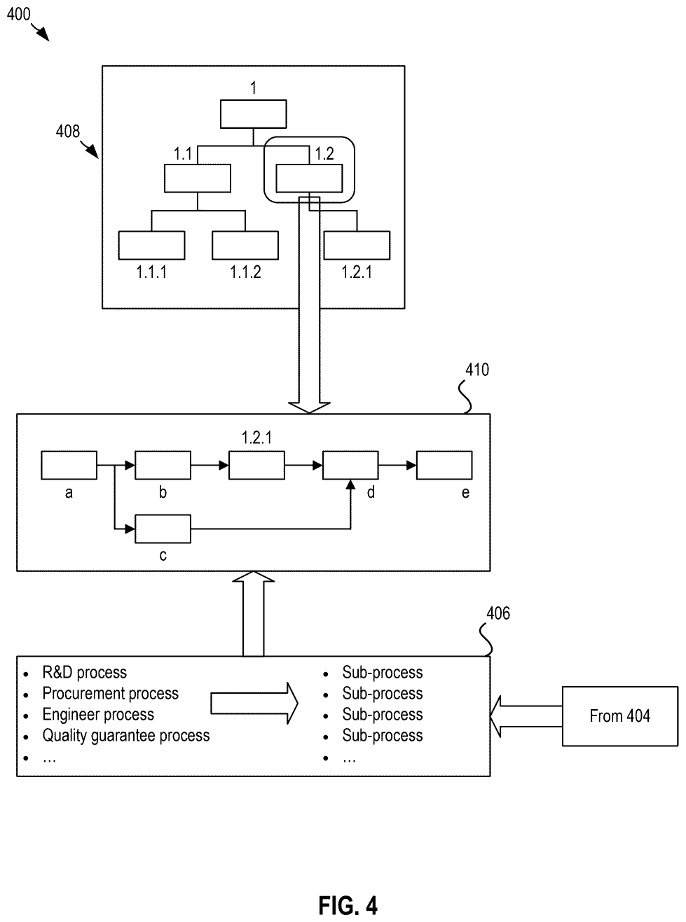

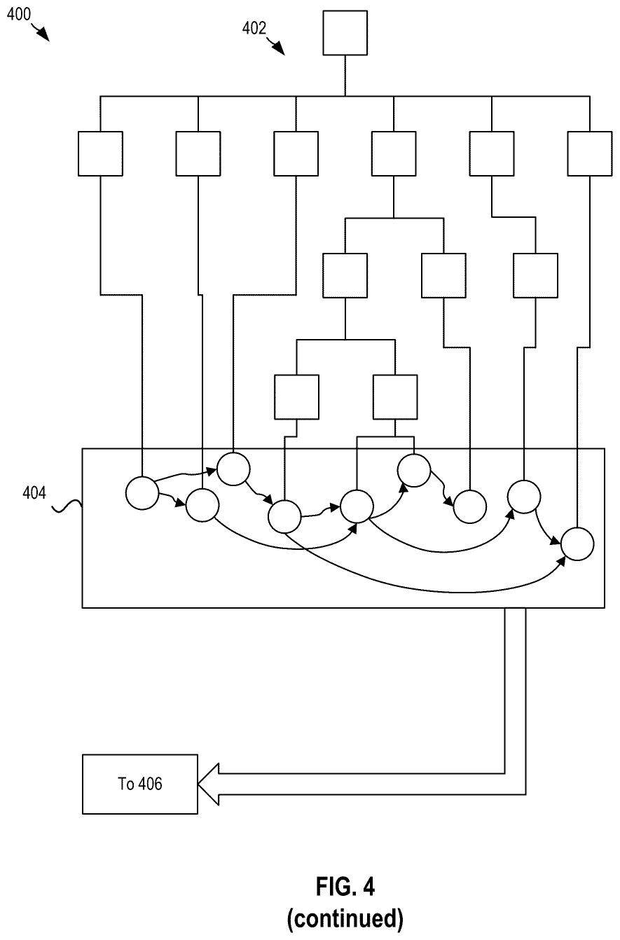

FIG. 4 depicts a flowchart 400 of architectures, in accordance with one approach. As an option, the present flowchart 400 may be implemented in conjunction with features from any other approach listed herein, such as those described with reference to the other FIGS. Of course, however, such flowchart 400 and others presented herein may be used in various applications and/or in permutations which may or may not be specifically described in the illustrative approaches listed herein. Further, the flowchart 400 presented herein may be used in any desired environment.

A first of the architectures of the flowchart includes an activity architecture 402. The activity architecture 402 includes a plurality of tiers that document and structure data of activities associated with development and production of previous products. This data may be added to a data lake that is used to train an AI model. Data of the activity architecture 402 may be analyzed by a trained AI model to identify processes and sub-processes of the processes, e.g., see analysis operation 404 that generates a list 406 of processes and sub-processes.

These processes and sub-processes may, in some approaches, be analyzed by the trained AI model to determine whether inefficiencies are present therein. This way, an execution plan architecture 408 may be established and refined for the development and production of a first product. For example, box 410 of the flowchart 400 illustrates a sub-process of steps 1.2.1 of the process 1.2 of the execution plan architecture 408. Process 1.2 is one of a plurality of the processes that are to be performed during the development and production of the first product, e.g., see execution plan architecture 408. In order to refine (mitigate inefficiencies) the process 1.2 steps of the process 1.2 and the sub-processes 1.2.1 are evaluated in box 410 by the trained AI model to identify inefficiencies within the processes and sub-processes, e.g., specifically inefficiencies between a starting step “a” and a destination step “e”. For example, in some preferred approaches, these inefficiencies may be based on predetermined research and development priorities including time, quality and/or cost. In some approaches, a solution to mitigate inefficiencies of the process 1.2 may be determined to perform step “c” rather than performing the logical path that includes step “b.” The determined solutions are caused to be incorporated into the development and production of the first product.

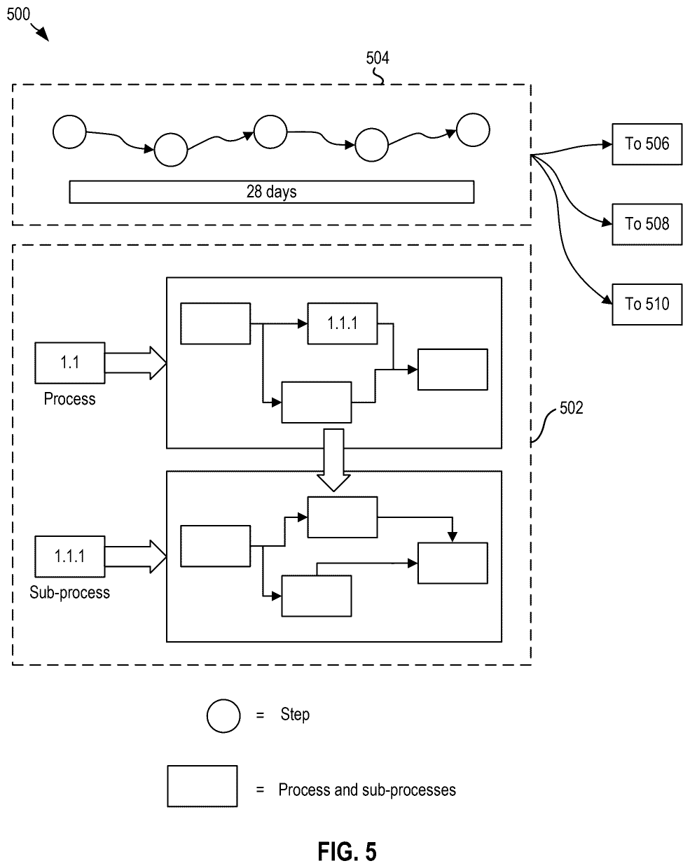

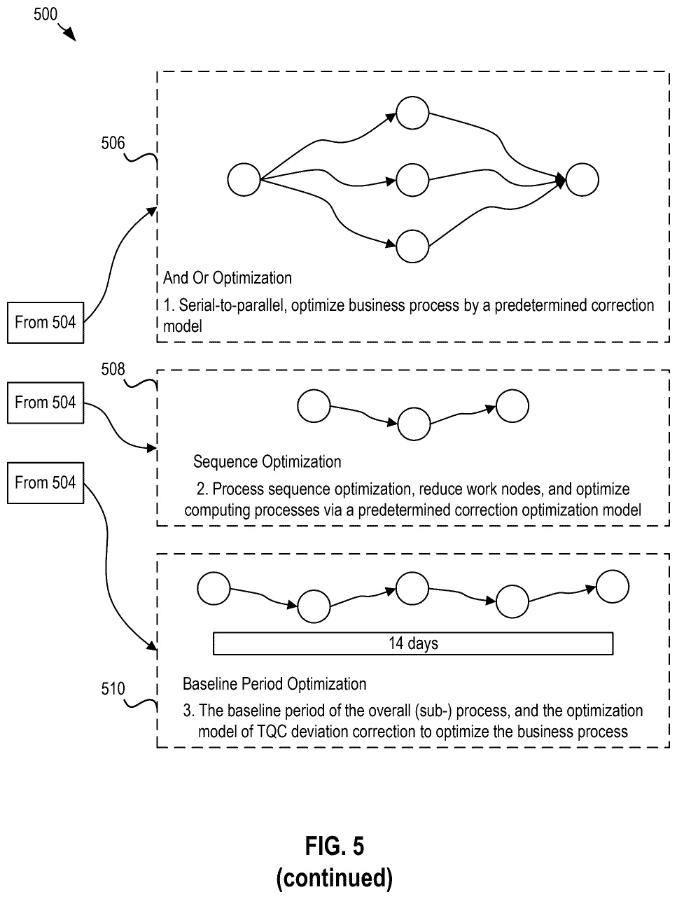

FIG. 5 depicts a flowchart 500 of optimizations of processes and sub-processes of the processes, in accordance with one approach. As an option, the present flowchart 500 may be implemented in conjunction with features from any other approach listed herein, such as those described with reference to the other FIGS. Of course, however, such flowchart 500 and others presented herein may be used in various applications and/or in permutations which may or may not be specifically described in the illustrative approaches listed herein. Further, the flowchart 500 presented herein may be used in any desired environment.

The flowchart 500 illustrates an architecture of a first sub-process 1.1 and a sub-process 1.1.1 of the process 1.1 in box 502. Steps of the sub-process 1.1.1 are evaluated in box 504 to determine whether any optimization techniques may be performed to mitigate inefficiencies from the process and sub-process of the process. For example, in box 506, a trained AI model may be caused to identify inefficiencies within steps of the sub-processes using a predetermined and/or optimization technique (note that the predetermined and/or optimization technique is described in greater detail elsewhere herein). Similarly, in box 508, steps of the sub-process 1.1.1 are evaluated to determine whether inefficiencies may be mitigated using a predetermined sequence optimization technique (note that the predetermined sequence optimization technique is described in greater detail elsewhere herein). Furthermore, in box 510, steps of the sub-process 1.1.1 are evaluated to determine whether inefficiencies may be mitigated using a predetermined baseline period optimization technique (note that the predetermined baseline period optimization technique is described in greater detail elsewhere herein).

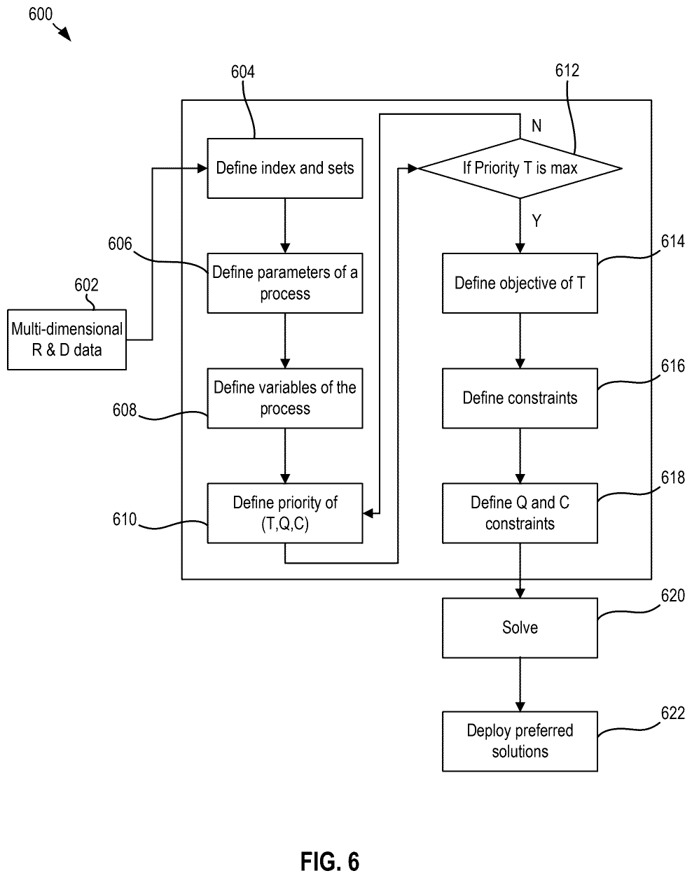

Now referring to FIG. 6, a flowchart of a method 600 is shown according to one approach. The method 600 may be performed in accordance with aspects of the present invention in any of the environments depicted in FIGS. 1-6, among others, in various approaches. Of course, more or fewer operations than those specifically described in FIG. 6 may be included in method 600, as would be understood by one of skill in the art upon reading the present descriptions.

Each of the steps of the method 600 may be performed by any suitable component of the operating environment. For example, in various approaches, the method 600 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

Operation 602 includes obtaining data to generate and maintain an architecture of data associated with a development and production of a product. In some approaches, this data includes multi-dimensional research and development parameters, unit of research and development cost, research and development qualification rate limits, etc.

Operation 604 includes defining indexes and collections within the data. According to several illustrative approaches, these indexes and collections may include a vehicle product birth process collection, a product model collection, whether a whole vehicle product is born from a collection of sub-processes, other predetermined collections, etc. Defining indexes and collections may be performed in order to initially structure the data before analysis by a trained AI model.

Research and development related parameters of a process may additionally and/or alternatively be defined, e.g., see operation 606. In some approaches, the parameters include unit parameters and constraint parameters that are to be followed during development and production of the product. In some approaches, the parameters include a cost of a phase activity corresponding to the process, e.g., unit cost. In some other approaches, the parameters may additionally and/or alternatively include a time of the phase activity corresponding to the process, e.g., unit time. In yet another approach, the parameters may additionally and/or alternatively include a research and development quality of the phase activity corresponding to the process, e.g., unit quality. The parameters may additionally and/or alternatively include a minimum product qualification rate constraint, e.g., constraint quality, and/or delivery restrictions, e.g., constrain lead time.

Operation 608 includes defining variables of the process. Variables of the process may be used to determine a breadth of a scope of the project as well as the conditions that may be experienced within that scope. The variables may, in some approaches, be represented as a binary value, e.g., true or false, or as an integer that characterizes the variable. According to some approaches, these variables may include whether a product model or a process is developed, e.g., binary. In some other approaches, the variables may include a number of deliverables in a certain stage of a product model, e.g., integer. In yet some other approaches, the variables may include whether a product model is developed in a research and development sub-process, e.g., binary. In yet some further approaches, the variables may include an amount of research and development of a product in a sub-process, e.g., integer.

A priority of predetermined research and development priorities are defined in operation 610. These predetermined research and development priorities include time for planning and executing development and production of the product (T), product quality (Q) and cost of development and production of the product (C). In some approaches, these priorities may be set by applying different weight values to the priorities, which may be dynamically adjusted over time. In some approaches in which the product is a vehicle, the time priority may specify that the development cycle of the new vehicle must be two to three years, and the cycle of a modified vehicle must be less than fifteen months.

In some optional approaches, a determination may be made as to whether the priority T has a relatively highest priority, e.g., see decision 612. In response to a determination that T has a relatively highest priority, the other two priorities (Q, C) are transformed into constraints, and vice versa.

In some approaches, one or more objective function(s) are constructed based on research and development parameters and target variables, e.g., see operation 614. Various illustrative examples of such functions are provided below.

$$Min Total Cost C = \sum Variables\_num * Parameters\_cost$$

$$Min Total Time T = \sum Variables\_num * Parameters\_time$$

$$Min Total Time Q = \sum Variables\_num * Parameters\_quality$$

Constraints may additionally and/or alternatively be constructed based on the research and development parameters and target variables, e.g., see operation 616.
Num1: Meet the minimum product pass rate constraint

$$\sum Variables\_num * Parameters\_quality \geq Q\_U / i$$

Num2: Meet delivery restrictions

$$\sum Variables\_num * Parameters\_time \leq T\_U / i$$

Similar constraints may be defined for the quality and cost priorities, e.g., see operation 618.

The priorities, objectives and constraints may be used by a trained AI model to identify inefficiencies within processes and sub-processes identified within the architecture of data mentioned above. This way, the trained AI model may be caused to determine and execute solutions (see operations 620 and 622) for mitigating the inefficiencies during the development and production of the product, e.g., using techniques described elsewhere above. In some approaches in which the product is a car, these solutions may include the manufacturing process of the vehicle integrating die-cast rear floors in order to reduce the vehicle weight 10% and cost of the vehicle 40%. Furthermore, in some approaches, the solutions may additionally and/or alternatively include upgrade to a new research and development platform through technical means, without affecting car performance while reducing the use of special raw materials such as silicon carbide to effectively reduce costs of producing the vehicle.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
generating and maintaining an architecture of data associated with a development and production of a product;
causing a trained artificial intelligence (AI) model to identify, within the architecture of data, processes and sub-processes of the processes;
causing the trained AI model to identify inefficiencies within the processes and sub-processes, wherein the inefficiencies are based on predetermined research and development priorities including: time, quality and cost;
determining solutions for mitigating the identified inefficiencies; and
causing the solutions to be incorporated into the development and production of the product.

2. The method of claim 1, wherein the product is a vehicle, wherein the processes are selected from the group consisting of: determining a start-up plan for the vehicle, defining production of the vehicle, preparing for initiation of the determined start-up plan, initiating the determined start-up plan, seeking investment approval for the vehicle, anticipating delays, determining conditions of the vehicle, research and development of the vehicle, identifying a pilot for the vehicle, producing a relatively small sample lot of the vehicle, performing quality control based on the relatively small sample lot of the vehicle, and associating an end of the product.

3. The method of claim 1, further comprising:
training the AI model to identify training processes and training sub-processes within a predetermined training set of data, wherein training the AI model includes:
causing the AI model to analyze the predetermined training set of data;
causing the AI model to make a guess as to the training processes and the training sub-processes within the predetermined training set of data; and
in response to a determination that the guess is correct, providing reward based feedback to the AI model to increase an accuracy of the model.

4. The method of claim 3, wherein the AI model is determined to be trained in response to a determination that the accuracy of the AI model exceeds a predetermined threshold of accuracy.

5. The method of claim 1,
wherein causing the trained AI model to identify inefficiencies within the processes and sub-processes comprises:
causing the trained AI model to identify a first of the processes having a starting point and a destination point,
wherein the first process includes a plurality of sub-processes that, along a serial logical path, include associated points between the starting point and the destination point,
wherein the determining solutions for mitigating the identified inefficiencies comprises:
causing the trained AI model to split points of the sub-processes along the serial logical path into a plurality of parallel logical paths each having the points of an associated one of the sub-processes,
wherein the causing the solutions to be incorporated into the development and production of the product comprises:
causing the sub-process of a first of the parallel logical paths to be performed during the development and production of the product, and
causing the sub-processes of a remainder of the parallel logical paths to not be performed during the development and production of the product.

6. The method of claim 5, wherein the performance of the first parallel logical path results in the development and production of the product in relatively less time than a resulting time of a performance of any of the logical paths of the remainder of the parallel logical paths for the development and production of the product.

7. The method of claim 6, wherein the performance of the first parallel logical path results in the development and production of the product for relatively less cost than a cost associated with a performance of any of the logical paths of the remainder of the parallel logical paths for the development and production of the product.

8. The method of claim 7, wherein the performance of the first parallel logical path results in the development and production of the product with relatively more product quality than a product quality associated with a performance of any of the logical paths of the remainder of the parallel logical paths for the development and production of the product.

9. The method of claim 1,
wherein causing the trained AI model to identify inefficiencies within the processes and sub-processes comprises:
causing the trained AI model to identify a first of the processes having a starting point and a destination point,
wherein the first process includes a sub-process having associated points between the starting point and the destination point,
wherein the determining solutions for mitigating the identified inefficiencies comprises:
causing the trained AI model to identify a first of the points of the sub-process that does not satisfy thresholds associated with the predetermined research and development priorities,
wherein the causing the solutions to be incorporated into the development and production of the product comprises:
causing the first point to be removed from the sub-process during performance of the development and production of the product.

10. A computer program product comprising:
one or more computer-readable storage media; and
program instructions stored on the one or more storage media to perform operations comprising:
generating and maintaining an architecture of data associated with a development and production of a product;
causing a trained artificial intelligence (AI) model to identify, within the architecture of data, processes and sub-processes of the processes;
causing the trained AI model to identify inefficiencies within the processes and sub-processes, wherein the inefficiencies are based on predetermined research and development priorities including: time, quality and cost;
determining solutions for mitigating the identified inefficiencies; and
causing the solutions to be incorporated into the development and production of the product.

11. The computer program product of claim 10, wherein the product is a vehicle, wherein the processes are selected from the group consisting of: determining a start-up plan for the vehicle, defining production of the vehicle, preparing for initiation of the determined start-up plan, initiating the determined start-up plan, seeking investment approval for the vehicle, anticipating delays, determining conditions of the vehicle, research and development of the vehicle, identifying a pilot for the vehicle, producing a relatively small sample lot of the vehicle, performing quality control based on the relatively small sample lot of the vehicle, and associating an end of the product.

12. The computer program product of claim 10, wherein the operations further comprise:
training the AI model to identify training processes and training sub-processes within a predetermined training set of data, wherein training the AI model includes:
causing the AI model to analyze the predetermined training set of data;
causing the AI model to make a guess as to the training processes and the training sub-processes within the predetermined training set of data; and
in response to a determination that the guess is correct, providing reward based feedback to the AI model to increase an accuracy of the model.

13. The computer program product of claim 12, wherein the AI model is determined to be trained in response to a determination that the accuracy of the AI model exceeds a predetermined threshold of accuracy.

14. The computer program product of claim 10,
wherein causing the trained AI model to identify inefficiencies within the processes and sub-processes comprises:
causing the trained AI model to identify a first of the processes having a starting point and a destination point,
wherein the first process includes a plurality of sub-processes that, along a serial logical path, include associated points between the starting point and the destination point,
wherein the determining solutions for mitigating the identified inefficiencies comprises:
causing the trained AI model to split points of the sub-processes along the serial logical path into a plurality of parallel logical paths each having the points of an associated one of the sub-processes,
wherein the causing the solutions to be incorporated into the development and production of the product comprises:
causing the sub-process of a first of the parallel logical paths to be performed during the development and production of the product, and
causing the sub-processes of a remainder of the parallel logical paths to not be performed during the development and production of the product.

15. The computer program product of claim 14, wherein the performance of the first parallel logical path results in the development and production of the product in relatively less time than a resulting time of a performance of any of the logical paths of the remainder of the parallel logical paths for the development and production of the product.

16. The computer program product of claim 15, wherein the performance of the first parallel logical path results in the development and production of the product for relatively less cost than a cost associated with a performance of any of the logical paths of the remainder of the parallel logical paths for the development and production of the product.

17. The computer program product of claim 16, wherein the performance of the first parallel logical path results in the development and production of the product with relatively more product quality than a product quality associated with a performance of any of the logical paths of the remainder of the parallel logical paths for the development and production of the product.

18. The computer program product of claim 10,
wherein causing the trained AI model to identify inefficiencies within the processes and sub-processes comprises:
causing the trained AI model to identify a first of the processes having a starting point and a destination point,
wherein the first process includes a sub-process having associated points between the starting point and the destination point,
wherein the determining solutions for mitigating the identified inefficiencies comprises:
causing the trained AI model to identify a first of the points of the sub-process that does not satisfy thresholds associated with the predetermined research and development priorities,
wherein the causing the solutions to be incorporated into the development and production of the product comprises:
causing the first point to be removed from the sub-process during performance of the development and production of the product.

19. A computer system comprising:
a processor set;
one or more computer-readable storage media; and
program instructions stored on the one or more storage media to cause the processor set to perform operations comprising:
generating and maintaining an architecture of data associated with a development and production of a product;
causing a trained artificial intelligence (AI) model to identify, within the architecture of data, processes and sub-processes of the processes;
causing the trained AI model to identify inefficiencies within the processes and sub-processes, wherein the inefficiencies are based on predetermined research and development priorities including: time, quality and cost;
determining solutions for mitigating the identified inefficiencies; and
causing the solutions to be incorporated into the development and production of the product.

20. The computer system of claim 19, wherein the product is a vehicle, wherein the processes are selected from the group consisting of: determining a start-up plan for the vehicle, defining production of the vehicle, preparing for initiation of the determined start-up plan, initiating the determined start-up plan, seeking investment approval for the vehicle, anticipating delays, determining conditions of the vehicle, research and development of the vehicle, identifying a pilot for the vehicle, producing a relatively small sample lot of the vehicle, performing quality control based on the relatively small sample lot of the vehicle, and associating an end of the product.
